(19) United States
(12) Patent Application Publication
(10) Pub. No.: US 2024/0359236 A1
(43) Pub. Date: Oct. 31, 2024

(54) METHOD FOR MANUFACTURING THREE-DIMENSIONAL OBJECT

(71) Applicant: SEIKO EPSON CORPORATION, Tokyo (JP)

(72) Inventor: Shigeru YAMAZAKI, Shiojiri (JP)

(21) Appl. No.: 18/645,471

(22) Filed: Apr. 25, 2024

(30) Foreign Application Priority Data
Apr. 27, 2023 (JP) 2023-073067

(51) Int. Cl. B22F 10/47; B22F 10/85; B28B 1/00; B28B 17/00; B33Y 10/00; B33Y 40/20; B33Y 50/02

(52) U.S. Cl. CPC B22F 10/47; B22F 10/85; B28B 1/001; B28B 17/0081; B33Y 10/00; B33Y 40/20; B33Y 50/02

(57) ABSTRACT

There is provided a method for manufacturing a three-dimensional object including: modeling an object by extruding a material onto a stage to deposit layers; and modeling a support structure in at least a part of a support area for supporting the object. The support area includes a first support area, a second support area adjacent to the first support area, and a third support area. The manufacturing method includes: a first step of modeling a first support structure in the first support area under a first modeling condition, and modeling a second support structure in the second support area under a second modeling condition, or forming a space without extruding the material; and a second step of separating the support structure from the object. The third support area is located between the second support area and the object, and the first modeling condition and the second modeling condition are modeling conditions different from each other.

The present application is based on, and claims priority from JP Application Serial Number 2023-073067, filed Apr. 27, 2023, the disclosure of which is hereby incorporated by reference herein in its entirety.

### BACKGROUND

### 1. Technical Field

The present disclosure relates to a method for manufacturing a three-dimensional object.

### 2. Related Art

JP-T-2021-511990 discloses a method for additive manufacturing including forming a second layer structure at a first layer structure and a first support structure, and removing the first support structure from the second layer structure.

JP-T-2021-511990 is an example of the related art.

By forming a support layer for supporting an object as in the first support structure disclosed in JP-T-2021-511990, shape collapse of the object can be prevented and modeling can be precisely performed. Meanwhile, when the support layer is formed, work of removing the support layer is required, and a burden on a user is large.

### SUMMARY

According to a first aspect of the present disclosure, there is provided a method for manufacturing a three-dimensional object including: modeling an object by extruding a material onto a stage to deposit layers; and modeling a support structure in at least a part of a support area for supporting the object. The support area includes a first support area, a second support area adjacent to the first support area, and a third support area. The manufacturing method includes: a first step of modeling a first support structure in the first support area under a first modeling condition, and modeling a second support structure in the second support area under a second modeling condition, or forming a space without extruding the material; and a second step of separating the support structure from the object. The third support area is located between the second support area and the object, and the first modeling condition and the second modeling condition are modeling conditions different from each other.

### BRIEF DESCRIPTION OF THE DRAWINGS

FIG. 1 is a diagram showing a schematic configuration of a three-dimensional modeling system in a first embodiment.

FIG. 2 is a perspective view showing a schematic configuration of a flat screw.

FIG. 3 is a schematic plan view of a barrel.

FIG. 4 is a diagram schematically showing a state in which a three-dimensional modeling apparatus models an object.

FIG. 5 is a diagram showing a schematic configuration of an information processing apparatus.

FIG. 6 is a diagram of model data generated by a data generation unit.

FIG. 7 is a flowchart of modeling processing.

FIG. 8 is a diagram showing an example of a modeling pattern.

FIG. 9 is a diagram of a filling rate.

FIG. 10 is a diagram of a contour.

FIG. 11 is a diagram showing a first screen example for designating a position of a second support area.

FIG. 12 is a diagram showing a second screen example for designating a position of the second support area.

FIG. 13 is a diagram of model data in a second embodiment.

FIG. 14 is a flowchart of modeling processing in a third embodiment.

FIG. 15 is a diagram showing a position in which an object is rotated by 90 degrees.

### DESCRIPTION OF EMBODIMENTS

### A. First Embodiment

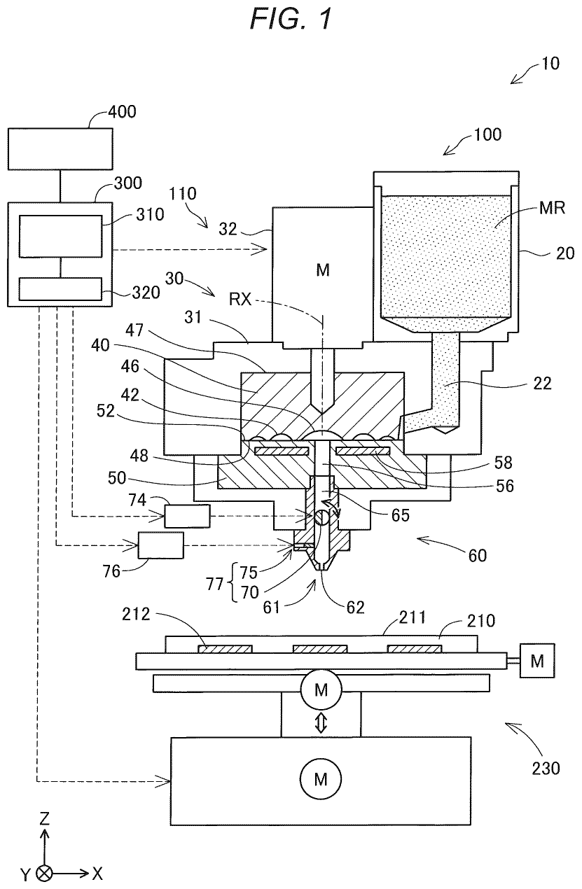

FIG. 1 is a diagram a schematic configuration of a three-dimensional modeling system 10 in a first embodiment. In FIG. 1, arrows indicating X, Y, and Z directions orthogonal to one another are shown. The X direction and the Y direction are directions parallel to a horizontal plane, and the Z direction is a direction along a vertically upward direction. Arrows indicating the X, Y, and Z directions are appropriately shown in other drawings in a manner in which shown directions correspond to those in FIG. 1. In the following description, when a direction is specified, a direction indicated by an arrow in each drawing is defined as “+” and an opposite direction is defined as “−”, and positive and negative signs are used in combination in a direction notation. Hereinafter, a +Z direction is also referred to as “upper”, and a −Z direction is also referred to as “lower”.

The three-dimensional modeling system 10 includes a three-dimensional modeling apparatus 100 and an information processing apparatus 400. The three-dimensional modeling apparatus 100 according to the embodiment is an apparatus that models an object by a material extrusion method. The three-dimensional modeling apparatus 100 includes a control unit 300 for controlling units of the three-dimensional modeling apparatus 100. The control unit 300 and the information processing apparatus 400 are communicably connected.

The three-dimensional modeling apparatus 100 includes a modeling unit 110 that generates and extrudes a modeling material, a modeling stage 210 serving as a base of the object, and a moving mechanism 230 that controls an extruding position of the modeling material.

The modeling unit 110 extrudes, under control of the control unit 300, a modeling material obtained by plasticizing a material in a solid state onto the stage 210. The modeling unit 110 includes a material supply unit 20 that is a supply source of a raw material before being converted into the modeling material, a plasticizing unit 30 that converts the raw material into the modeling material, and an extruding unit 60 that extrudes the modeling material.

The material supply unit 20 supplies a raw material MR to the plasticizing unit 30. The material supply unit 20 is implemented by, for example, a hopper that accommodates the raw material MR. The material supply unit 20 is coupled to the plasticizing unit 30 via a communication path 22. The raw material MR is put into the material supply unit 20 in the form of powder or pellets.

The plasticizing unit 30 plasticizes the raw material MR supplied from the material supply unit 20 to generate a paste-shaped modeling material exhibiting fluidity, and guides the modeling material to the extruding unit 60. In the embodiment, the term “plasticize” is a concept including melting, and is to change from a solid state to a flowable state. Specifically, in a case of a material in which glass transition occurs, the term “plasticize” refers to setting a temperature of the material equal to or higher than a glass transition point. In a case of a material in which the glass transition does not occur, the term “plasticize” refers to setting the temperature of the material equal to or higher than a melting point.

The plasticizing unit 30 includes a screw case 31, a drive motor 32, a flat screw 40, and a barrel 50. The flat screw 40 is also referred a rotor or a scroll. The barrel 50 is also called a screw facing portion.

The flat screw 40 is housed in the screw case 31. An upper surface 47 of the flat screw 40 is coupled to the drive motor 32, and the flat screw 40 is rotated in the screw case 31 by a rotational drive force generated by the drive motor 32. The drive motor 32 is driven under the control of the control unit 300. The flat screw 40 may be driven by the drive motor 32 via a speed reducer.

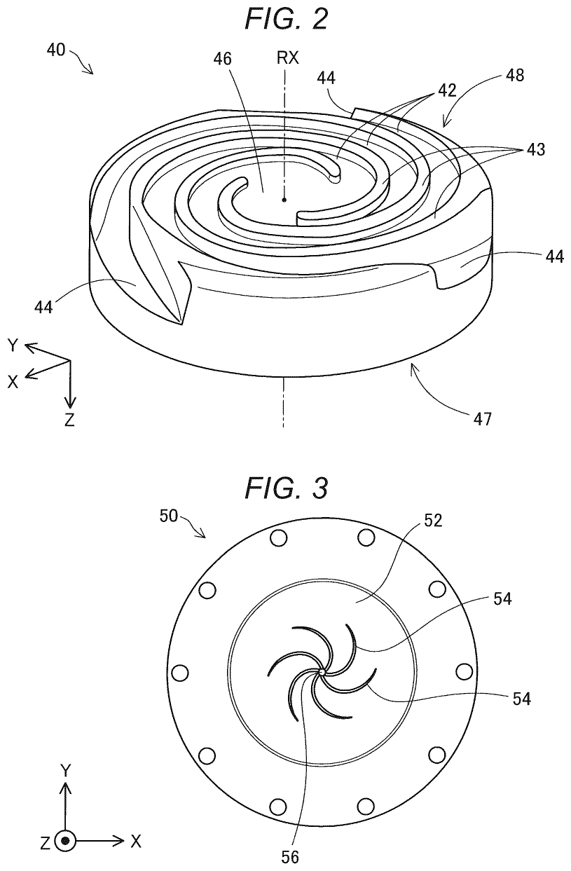

FIG. 2 is a perspective view showing a schematic configuration of a lower surface 48 side of the flat screw 40. To facilitate understanding of the technique, the flat screw 40 shown in FIG. 2 is shown in a state in which a positional relationship between the upper surface 47 and the lower surface 48 shown in FIG. 1 is reversed in a vertical direction. The flat screw 40 has a substantially columnar shape in which a length in an axial direction is smaller than a length in a direction perpendicular to the axial direction. The axial direction is a direction along a central axis of the flat screw 40. The flat screw 40 is placed such that a rotation axis RX serving as a rotation center of the flat screw 40 is parallel to the Z direction.

Groove portions 42 in a vortex shape are formed in the lower surface 48 of the flat screw 40 that is a surface intersecting the rotation axis RX. The above-described communication path 22 of the material supply unit 20 communicates with the groove portions 42 from a side surface of the flat screw 40. In the embodiment, three groove portions 42 are formed in a manner of being separated by ridge portions 43. The number of the groove portions 42 is not limited to three, and may be one or two or more. A shape of the groove portion 42 is not limited to a vortex shape, and may have a spiral shape or an involute curve shape, or may have a shape extending in an arc from a central portion toward an outer periphery.

As shown in FIG. 1, the lower surface 48 of the flat screw 40 faces an upper surface 52 of the barrel 50, and a space is formed between the groove portions 42 of the lower surface 48 of the flat screw 40 and the upper surface 52 of the barrel 50. The raw material MR is supplied from the material supply unit 20 to the space between the flat screw 40 and the barrel 50 through material inlets 44 shown in FIG. 2.

A barrel heater 58 for heating the raw material MR supplied into the groove portions 42 of the rotating flat screw 40 is embedded in the barrel 50. A communication hole 56 is provided at a center of the barrel 50.

FIG. 3 is a schematic plan view showing the upper surface 52 side of the barrel 50. A plurality of guide grooves 54 coupled to the communication hole 56 and extending in a vortex shape from the communication hole 56 toward an outer periphery are formed in the upper surface 52 of the barrel 50. One end of the guide groove 54 may not be coupled to the communication hole 56. The guide groove 54 may be omitted.

The raw material MR supplied into the groove portions 42 of the flat screw 40 flows along the groove portions 42 by the rotation of the flat screw 40 while being plasticized in the groove portions 42, and the raw material MR is guided to a central portion 46 of the flat screw 40 as the modeling material. The paste-shaped modeling material that exhibits fluidity and flows into the central portion 46 is supplied to the extruding unit 60 through the communication hole 56 provided at the center of the barrel 50. In the modeling material, not all types of substances constituting the modeling material may be plasticized. The modeling material may be converted into a flowable state as a whole by plasticizing at least a part of substances constituting the modeling material.

The extruding unit 60 shown in FIG. 1 includes a nozzle 61 that extrudes the modeling material, a modeling material flow path 65 formed between the flat screw 40 and a nozzle opening 62, and an extruding control unit 77 that controls extruding of the modeling material.

The nozzle 61 is coupled to the communication hole 56 of the barrel 50 through the flow path 65. The nozzle 61 extrudes the modeling material generated in the plasticizing unit 30 from the nozzle opening 62 at a tip end of the nozzle 61 toward the stage 210.

The extruding control unit 77 includes an extruding adjustment unit 70 that opens and closes the flow path 65, and a suction unit 75 that suctions and temporarily stores the modeling material.

The extruding adjustment unit 70 is provided in the flow path 65, and changes an opening degree of the flow path 65 by being rotated in the flow path 65. In the embodiment, the extruding adjustment unit 70 is implemented by a butterfly valve. The extruding adjustment unit 70 is driven by a first drive unit 74 under the control of the control unit 300. The first drive unit 74 is implemented by, for example, a stepping motor. The control unit 300 can adjust a flow rate of the modeling material flowing from the plasticizing unit 30 to the nozzle 61, that is, an extruding amount of the modeling material extruded from the nozzle 61, by controlling a rotation angle of the butterfly valve using the first drive unit 74. The extruding adjustment unit 70 can adjust the extruding amount of the modeling material and can control ON and OFF of an outflow of the modeling material.

The suction unit 75 is coupled between the extruding adjustment unit 70 and the nozzle opening 62 in the flow path 65. The suction unit 75 temporarily suctions the modeling material in the flow path 65 when extruding of the modeling material from the nozzle 61 is stopped, thereby preventing a tailing phenomenon in which the modeling material drips down from the nozzle opening 62 as if pulling a string. In the embodiment, the suction unit 75 is implemented by a plunger. The suction unit 75 is driven by a second drive unit 76 under the control of the control unit 300. The second drive unit 76 is implemented by, for example, a stepping motor, and a rack-and-pinion mechanism that converts a rotation force of the stepping motor into a translational motion of a plunger.

The stage 210 is placed at a position facing the nozzle opening 62 of the nozzle 61. In the first embodiment, a modeling surface 211 of the stage 210 facing the nozzle opening 62 of the nozzle 61 is placed in parallel to the X and Y directions, that is, a horizontal direction. The stage 210 includes a stage heater 212 for preventing rapid cooling of the modeling material extruded onto the stage 210. The stage heater 212 is controlled by the control unit 300.

The moving mechanism 230 changes a relative position between the stage 210 and the nozzle 61 under the control of the control unit 300. In the embodiment, a position of the nozzle 61 is fixed, and the moving mechanism 230 moves the stage 210. The moving mechanism 230 is implemented by a three-axis positioner that moves the stage 210 in three axial directions of the X, Y, and Z directions by drive forces of three motors. In the present description, unless otherwise specified, a movement of the nozzle 61 refers to moving the nozzle 61 or the extruding unit 60 relative to the stage 210.

In another embodiment, a configuration in which the moving mechanism 230 moves the nozzle 61 relative to the stage 210 in a state in which a position of the stage 210 is fixed may be adopted instead of a configuration in which the stage 210 is moved by the moving mechanism 230. A configuration in which the stage 210 is moved in the Z direction by the moving mechanism 230 and the nozzle 61 is moved in the X and Y directions or a configuration in which the stage 210 is moved in the X and Y directions by the moving mechanism 230 and the nozzle 61 is moved in the Z direction may be adopted. With such configurations, a relative positional relationship between the nozzle 61 and the stage 210 can also be changed.

Although only one modeling unit 110 is shown in FIG. 1, it is assumed that the three-dimensional modeling apparatus 100 in the embodiment includes three modeling units 110. Among the three modeling units 110, a modeling material containing a first metal and a resin to be described later is extruded from the first modeling unit 110, a modeling material containing a second metal and a resin to be described later is extruded from the second modeling unit 110, and a modeling material containing a ceramic and a resin to be described later is extruded from the third modeling unit 110.

The control unit 300 is a control device that controls an overall operation of the three-dimensional modeling apparatus 100. The control unit 300 is implemented by a computer including one or more processors 310, a storage device 320 including a main storage device and an auxiliary storage device, and an input and output interface that inputs a signal from and outputs a signal to an outside. The processor 310 executes a program stored in the storage device 320, thereby controlling the modeling unit 110 and the moving mechanism 230 according to modeling data acquired from the information processing apparatus 400 to model an object on the stage 210. The control unit 300 may be implemented by a combination of circuits instead of being implemented by a computer.

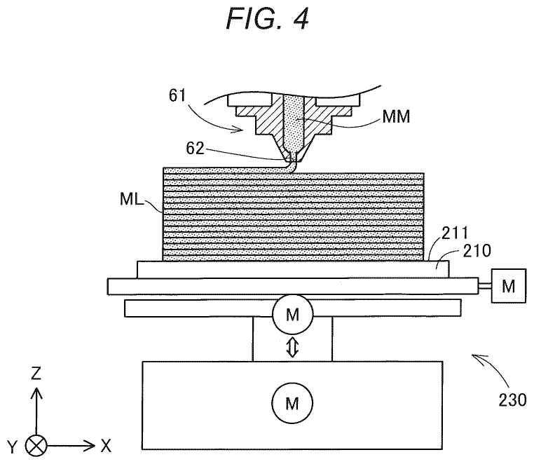

FIG. 4 is a diagram schematically showing a state in which the three-dimensional modeling apparatus 100 models an object. As described above, the raw material MR in a solid state is plasticized to generate a modeling material MM in the three-dimensional modeling apparatus 100. The control unit 300 causes the nozzle 61 to extrude the modeling material MM while changing a position of the nozzle 61 relative to the stage 210 in a direction along the modeling surface 211 of the stage 210 and maintaining a distance between the modeling surface 211 of the stage 210 and the nozzle 61. The modeling material MM extruded from the nozzle 61 is continuously stacked in a moving direction of the nozzle 61.

The control unit 300 forms layers ML by repeating a movement of the nozzle 61. After forming one layer ML, the control unit 300 moves a position of the nozzle 61 relative to the stage 210 in the Z direction. A layer ML is further deposited on the layer ML that is formed so far, thereby modeling an object.

For example, the control unit 300 may temporarily interrupt a movement of the nozzle 61 in the Z direction when the layer ML for one layer is completed, or temporarily interrupt extruding of the modeling material from the nozzle 61 when there are a plurality of independent modeling areas in each layer. In this case, the flow path 65 is closed by the extruding adjustment unit 70, extruding of the modeling material MM from the nozzle opening 62 is stopped, and the modeling material in the nozzle 61 is temporarily suctioned by the suction unit 75. After the control unit 300 changes the position of the nozzle 61, the extruding adjustment unit 70 opens the flow path 65 while discharging the modeling material in the suction unit 75, thereby restarting stacking of the modeling material MM from a changed position of the nozzle 61.

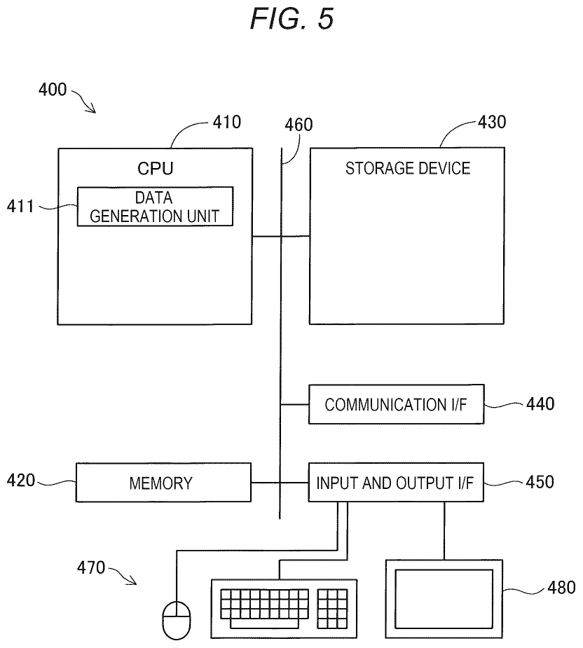

FIG. 5 is a diagram showing a schematic configuration of the information processing apparatus 400. The information processing apparatus 400 is implemented as a computer in which a CPU 410, a memory 420, a storage device 430, a communication interface 440, and an input and output interface 450 are coupled to each other by a bus 460. An input device 470 such as a keyboard and a mouse and a display device 480 such as a liquid crystal display are coupled to the input and output interface 450. The information processing apparatus 400 is coupled to the control unit 300 of the three-dimensional modeling apparatus 100 via the communication interface 440.

The CPU 410 functions as a data generation unit 411 by executing a program stored in the storage device 430.

The data generation unit 411 generates model data for modeling an object and a support structure. The support structure is a structure modeled in at least a part of a support area for supporting the object.

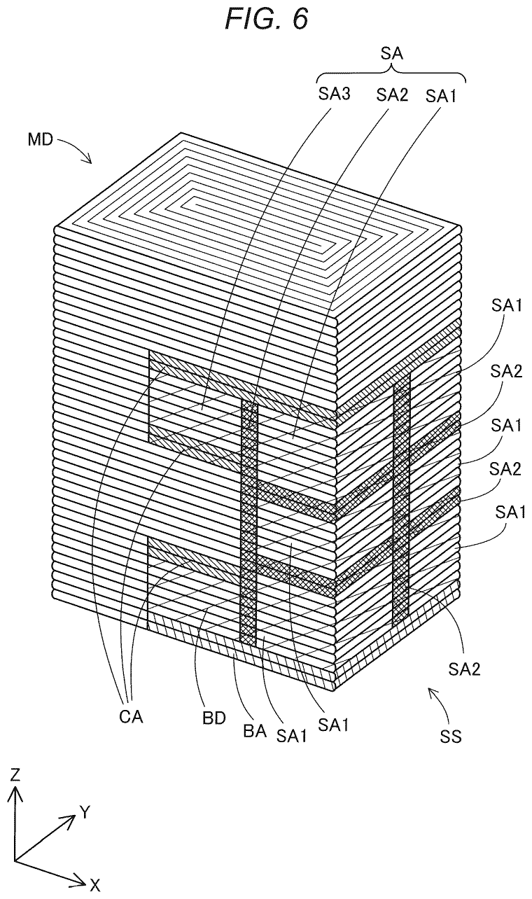

FIG. 6 is a diagram of model data generated by the data generation unit 411. The model data includes main body data for modeling a main body of an object MD and support data for modeling a support structure SS. In FIG. 6, a portion not hatched indicates the main body of the object MD, and a portion hatched indicates the support structure SS. A support area SA in which the support structure SS is modeled includes a first support area SA1, a second support area SA2 adjacent to the first support area SA1, and a third support area SA3. The second support area SA2 is an area for facilitating separation between the first support areas SA1 and between the first support area SA1 and the third support area SA3.

The third support area SA3 has a positional relationship in which the third support area SA3 is located between the object MD and one of the first support area SA1 and the second support area SA2 that is closer to the object MD in a direction in which the first support area SA1 and the second support area SA2 are aligned. In the example in FIG. 6, the direction in which the first support area SA1 and the second support area SA2 are aligned is the X direction. In FIG. 6, one of the first support area SA1 and the second support area SA2 that is closer to the object MD is the second support area SA2. FIG. 6 shows four second support areas SA2. When a plurality of second support areas SA2 are in the support area SA, at least one of the second support areas SA2 has the above-described positional relationship with the first support area SA1, the third support area SA3, and the object MD.

The data generation unit 411 generates, based on different modeling conditions, data for modeling a first support structure in the first support area SA1 and data for modeling a second support structure in the second support area SA2. In the embodiment, the data generation unit 411 generates data for modeling a third support structure in the third support area SA3 based on the same modeling conditions as the data for modeling the first support structure in the first support area SA1.

In the embodiment, the object MD contains the first metal. That is, the object MD is modeled using a modeling material generated by plasticizing pellets containing the first metal and a resin. The first support structure and the third support structure contain the second metal. That is, the first support structure and the third support structure are modeled by a modeling material generated by plasticizing pellets containing the second metal and the resin. The first metal and the second metal may be the same kind of metal or different kinds of metals. The second support structure includes a ceramic. That is, the second support structure is modeled by a modeling material generated by plasticizing pellets including the ceramic and a resin. The object MD and the support structure SS modeled by these materials are heated and fired at a temperature equal to or higher than a sintering temperature of the first metal and the second metal and lower than a sintering temperature of the ceramic.

In the embodiment, the support area SA further includes a base area BA in contact with the stage 210, a contact area CA in contact with the object MD at an upper side or a lower side, and a body area BD different from the base area BA and the contact area CA. The second support area SA2 is an area in the body area BD among these areas. In the embodiment, the support structure SS is modeled in the base area BA and the contact area CA under the same modeling condition as that of the first support area SA1. The support structure SS may be modeled in the base area BA and the contact area CA under a modeling condition different from that of the first support area SA1.

The information processing apparatus 400 transmits the modeling data generated by the data generation unit 411 to the control unit 300 of the three-dimensional modeling apparatus 100. The control unit 300 controls the extruding unit 60 and the moving mechanism 230 according to the received modeling data to extrude a material and deposit layers ML in a depositing direction, thereby modeling the object MD and the support structure SS on the stage 210.

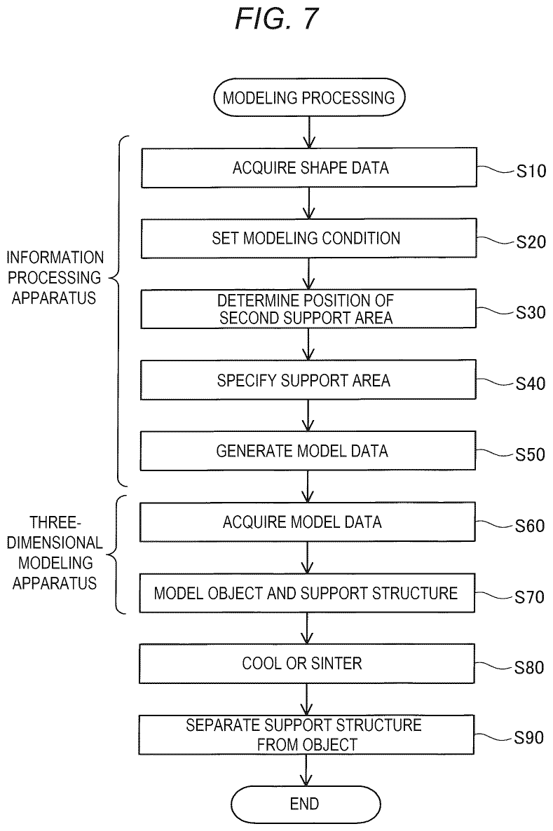

FIG. 7 is a flowchart of modeling processing executed in the three-dimensional modeling system 10. The modeling processing is processing for implementing a method for manufacturing a three-dimensional object. Processing of steps S10 to S50 shown in FIG. 7 is executed in the information processing apparatus 400, and processing of steps S60 to S70 is executed in the three-dimensional modeling apparatus 100.

In step S10, the data generation unit 411 of the information processing apparatus 400 acquires shape data representing a three-dimensional shape of the object MD from another computer, a recording medium, or the storage device 430. The shape data is data representing a shape of the three-dimensional object created using three-dimensional CAD software, three-dimensional CG software, or the like. As the shape data, for example, data in an STL format or an AMF format can be used.

In step S20, the data generation unit 411 receives setting of a modeling condition for modeling the support structure SS. The modeling condition includes a first modeling condition for modeling the first support structure and a second modeling condition for modeling the second support structure. A user uses the input device 470 to operate a setting screen displayed on the display device 480 to set the modeling condition. The modeling condition includes a condition related to at least one of a type of a material, a line width of the material, a depositing pitch of the material, a modeling pattern of the material, and presence or absence of a contour.

The type of the material is a condition designating a type of the modeling material extruded from the nozzle 61. As described above, in the embodiment, a material containing the second metal is set for the first support structure, and a material containing the ceramic is set for the second support structure, as the type of material.

The line width is a condition designating a width of the modeling material extruded from the nozzle 61. The line width is adjusted by changing an extruding amount per unit time of the modeling material extruded from the nozzle 61.

The depositing pitch is a condition designating a height of each layer to be deposited.

The modeling pattern is a condition designating a pattern indicating a movement path of the nozzle 61 for filling an inner area of each layer.

A filling rate is a condition designating an area ratio for filling the internal area with the designated modeling pattern. The modeling pattern is also referred to as a pass pattern.

The presence or absence of a contour is a condition as to whether to form a contour surrounding an outer periphery of the modeling pattern.

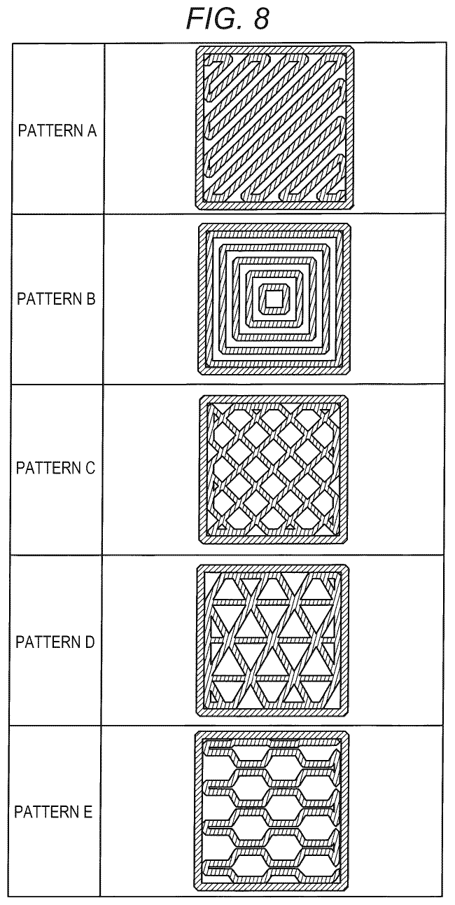

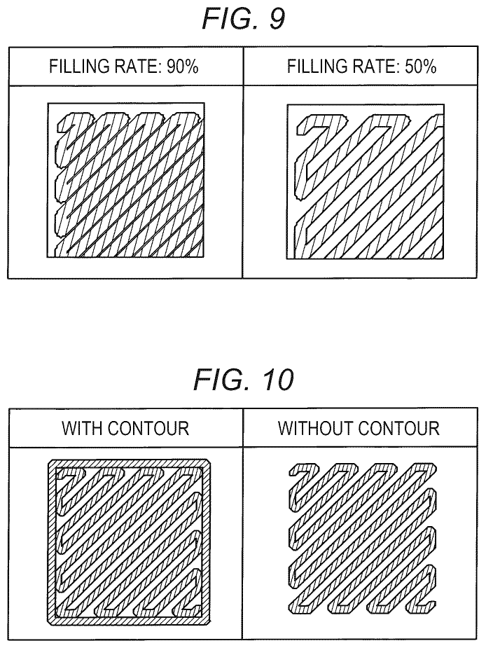

FIG. 8 is a diagram showing an example of the modeling pattern. In the embodiment, different modeling patterns from pattern A to pattern E shown in FIG. 8 can be designated as modeling patterns. Each of modeling patterns shown in FIG. 9 shows an example in which the modeling pattern is placed inside a contour for one round.

FIG. 9 is a diagram of the filling rate. FIG. 9 shows an example in which a filling rate of the modeling pattern A shown in FIG. 8 is changed to 90% and 50%. As shown in FIG. 9, as the filling rate increases, an interval between modeling materials forming the modeling pattern decreases.

FIG. 10 is a diagram of the contour. In FIG. 10, the modeling pattern A shown in FIG. 8 is shown with respect to each of a pattern with a contour and a pattern without a contour. When there is a contour, the number of cycles of the contour may be settable.

In the embodiment, modeling conditions are set for the first support area SA1 and the second support area SA2 such that a strength of the second support structure modeled under the second modeling condition is lower than that of the first support structure modeled under the first modeling condition. For example, a material that does not contain a metal has a lower strength than a material that contains a metal. The larger a line width of a material, the more likely voids occur within the support structure, resulting in a lower strength. The larger a depositing pitch of a material, the more likely voids occur within the support structure, resulting in a lower strength. The smaller a filling rate of a material, the more likely voids occur within the support structure, resulting in a lower strength. A strength of the contour is lower when not modeled.

In step S30 in FIG. 7, the data generation unit 411 determines a position of the second support area SA2 in the support area SA. In the embodiment, the position of the second support area SA2 is determined by receiving designation of the position of the second support area SA2 from the user through the input device 470.

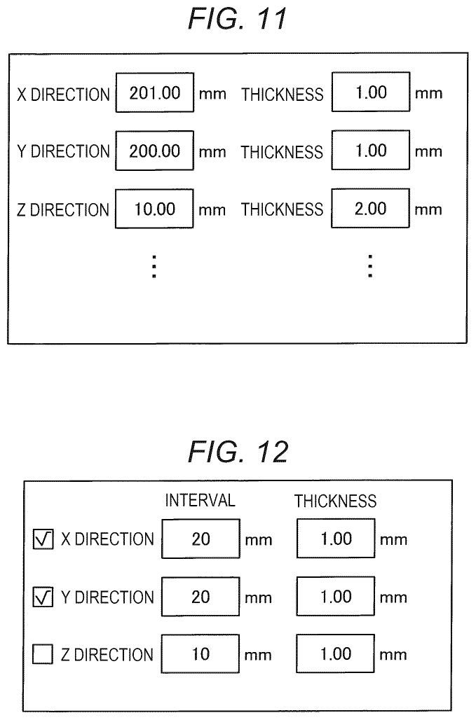

FIG. 11 is a diagram showing a first screen example for designating the position of the second support area SA2. The user designates the position of the second support area SA2 through a screen displayed on the display device 480. FIG. 11 shows an example in which positions of three second support areas SA2 are designated, which are the second support area SA2 having a position in the X direction of “201.00 mm” and a thickness along the X direction of “1.00 mm”, the second support area SA2 having a position in the Y direction of “200.00 mm” and a thickness along the Y direction of “1.00 mm”, and the second support area SA2 having a position in the Z direction of “10.00 mm” and a thickness along the Z direction of “2.00 mm”. Items shown in FIG. 11 are repeatedly displayed on the display device 480, and the user can place any number of second support areas SA2 at any position with respect to the support area SA by inputting a required number of second support areas SA2.

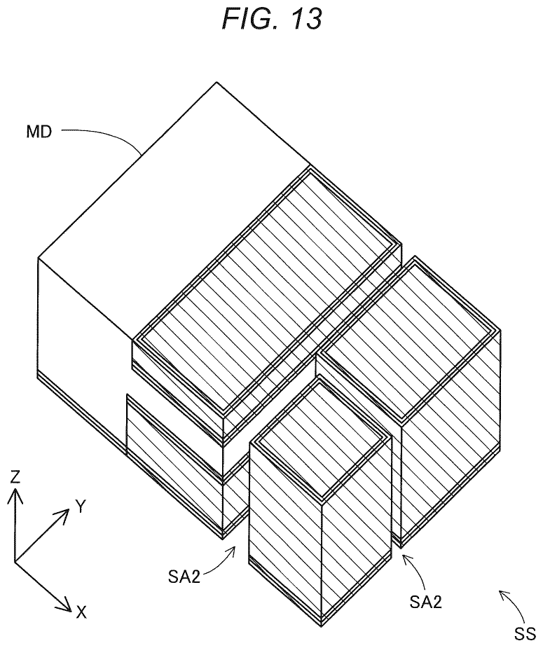

FIG. 12 is a diagram showing a second screen example for designating the position of the second support area SA2. In a screen shown in FIG. 12, the user can designate an interval at which the second support area SA2 is placed and a thickness of the second support area SA2 in each of the X direction, the Y direction, and the Z direction. In each of input items in the X direction, the Y direction, and the Z direction, a check box is provided for designating whether to place the second support area SA2 so as to correspond to the item. By using the screen shown in FIG. 12, the user can repeatedly place the second support area SA2 at designated intervals in any direction with respect to the support area SA.

In step S30 in FIG. 7, the data generation unit 411 may automatically set the position of the second support area SA2 without receiving designation from the user. For example, the data generation unit 411 may detect an uneven structure of an outer surface of the object MD and place the second support area SA2 such that the second support area SA2 extends from a corner of a projection portion along a protruding direction of the projection portion. The second support area SA2 may extend in a plane direction along a tip end surface of the projection portion. By detecting the uneven structure of the object MD, the data generation unit 411 can easily automatically set the position of the second support area SA2.

The position of the second support area SA2 placed by the user and the position of the second support area SA2 automatically placed by the data generation unit 411 may be freely changed by the user. For example, the user can freely move the second support area SA2 displayed on the display device 480 in the support area SA by dragging and dropping the second support area SA2 using a mouse.

In step S40 in FIG. 7, the data generation unit 411 specifies the support area SA. In step S40, the data generation unit 411 first analyzes the shape data acquired in step S10 and determines a range of the support area SA in which support structure SS can be placed. Specifically, the data generation unit 411 sets the support area SA at a lower part of an overhang portion of the object MD. The overhang portion refers to a protruding portion of the object MD that is not supported at a lower part. In the embodiment, a meaning of the overhang portion also includes a bridge portion. The bridge portion refers to a bridge-shaped portion whose both ends are supported in the object MD.

The data generation unit 411 specifies the base area BA, the contact area CA, and the body area BD within the range of the determined support area SA. The data generation unit 411 places, in the body area BD, the second support area SA2 designated in step S30. The data generation unit 411 specifies, as the first support area SA1, an area in the body area BD where the second support area SA2 is not placed. Further, the data generation unit 411 specifies, as the third support area SA3, an area in the specified first support area SA1 sandwiched between the object MD and the second support area SA2.

In step S50, the data generation unit 411 generates model data including main body data for modeling the object MD and support data for modeling the support structure SS.

In generating the main body data, the data generation unit 411 analyzes the shape data acquired in step S10 and slices a shape of the object MD into a plurality of layers along an XY plane. The data generation unit 411 generates movement path information representing a movement path of the nozzle 61 for forming a contour of each layer and filling an inner area with a predetermined filling rate or modeling pattern. The movement path information includes data representing a plurality of linear movement paths. Each movement path in the movement path information includes extruding amount information indicating an extruding amount of the modeling material extruded in the movement path. The data generation unit 411 generates the movement path information and the extruding amount information for all layers of the object MD to generate the main body data. The main body data is represented by, for example, a G code.

In generating the support data, the data generation unit 411 generates, in accordance with the modeling condition set in step S20, support data for modeling the support structure SS for the base area BA, the contact area CA, the first support area SA1, the second support area SA2, and the third support area SA3 specified in step S40. For example, the data generation unit 411 slices each support area into a plurality of layers along the XY plane according to the depositing pitch in the modeling condition. The data generation unit 411 generates movement path information for modeling each support area according to the line width, the modeling pattern, the filling rate, and the presence or absence of the contour in the modeling condition. Each movement path in the movement path information includes extruding amount information indicating an extruding amount of the modeling material extruded in the movement path. The data generation unit 411 generates the movement path information and the extruding amount information for all layers of the support area SA to generate the support data. The support data is represented by, for example, a G code, similarly to the main body data.

In step S60, the control unit 300 of the three-dimensional modeling apparatus 100 acquires the model data generated by the information processing apparatus 400 in step S50 from the information processing apparatus 400.

In step S70, the control unit 300 models, according to the model data acquired from the information processing apparatus 400, the object MD and the support structure SS at the modeling surface 211 of the stage 210 by controlling the extruding unit 60 and the moving mechanism 230. For example, of the support structure SS, the first support structure modeled in the first support area SA1 and the second support structure modeled in the second support area SA2 are modeled according to different modeling conditions set in step S20. Step S70 is also referred to as a first step.

In step S80, the object MD and the support structure SS are cooled or sintered. When the object MD and the support structure SS are modeled only by a resin, cooling is performed. In contrast, in the embodiment, since the object MD contains the first metal, the first support structure and the third support structure contain the second metal, and the second support structure contains the ceramic, sintering is performed in step S80. As described above, a sintering step is performed at a temperature equal to or higher than the sintering temperature of the first metal and the second metal and lower than the sintering temperature of the ceramic.

In step S90, the support t structure SS is separated from the object MD. In the embodiment, the second support structure is modeled under a modeling condition different from that of the first support structure. More specifically, the first support structure and the third support structure contain the second metal, the second support structure contains the ceramic, and the sintering is performed at a temperature equal to or higher than the sintering temperature of the first metal and the second metal and lower than the sintering temperature of the ceramic. Therefore, the second support structure placed between the first support structures or between the first support structure and the third support structure is not sintered, and the first support structure and the third support structure are sintered. Accordingly, the first support structures or the first support structure and the third support structure are easily separated. Step S90 is also referred to as a second step.

According to the first embodiment described above, the support structure SS is modeled under different modeling conditions for the first support area SA1 and the second support area SA2 adjacent to the first support area SA1. Therefore, the first support structures or the first support structure and the third support structure are easily separated. As a result, a burden on the user can be reduced.

In the embodiment, the modeling condition is a condition related to at least one of the type of the material, the line width of the material, the depositing pitch of the material, and the modeling pattern of the material. Therefore, by making these conditions different, the first support structure and the second support structure can have different strengths.

In the embodiment, in the support area SA, the second support structure is not modeled in the base area BA in contact with the stage 210 and the contact area CA in contact with the object MD at the upper side or the lower side. Therefore, the object MD can be brought into good contact with the support structure SS or the stage 210, and modeling accuracy of the object MD can be improved.

In the first embodiment, the first support structure is modeled by the material containing the metal, and the second support structure is modeled by the material containing the ceramic. In contrast, for example, the first support structure may be modeled by a water-insoluble resin, and the second support structure may be modeled by a water-soluble resin.

### B. Second Embodiment

In the first embodiment, the first support structure and the second support structure are modeled under different modeling conditions. In contrast, in a second embodiment, the second support structure is not modeled. A configuration of the three-dimensional modeling apparatus 100 in the second embodiment is the same as that in the first embodiment.

FIG. 13 is a diagram of model data in the second embodiment. FIG. 13 shows a state in which the overhang portion of the model data shown in FIG. 6 is omitted. In the second embodiment, in step S20 of the modeling processing shown in FIG. 7, the modeling condition is set such that the support structure SS is not modeled for the second support area SA2. Therefore, in step S50, support data for modeling the second support structure is not generated. In step S70, the second support structure is not modeled, and the support structure SS according to the modeling condition is modeled for each of the first support area SA1 and the third support area SA3.

According to the second embodiment described above, as shown in FIG. 13, no material is extruded to the second support area SA2, and a space is formed. Therefore, the first support structures or the first support structure and the third support structure are easily separated.

### C. Third Embodiment

A third embodiment is different from the first embodiment and the second embodiment in contents of the modeling processing. A configuration of the three-dimensional modeling apparatus 100 in the third embodiment is the same as that in the first embodiment. In the third embodiment, as in the second embodiment, a space is formed in the second support area SA2 as shown in FIG. 13.

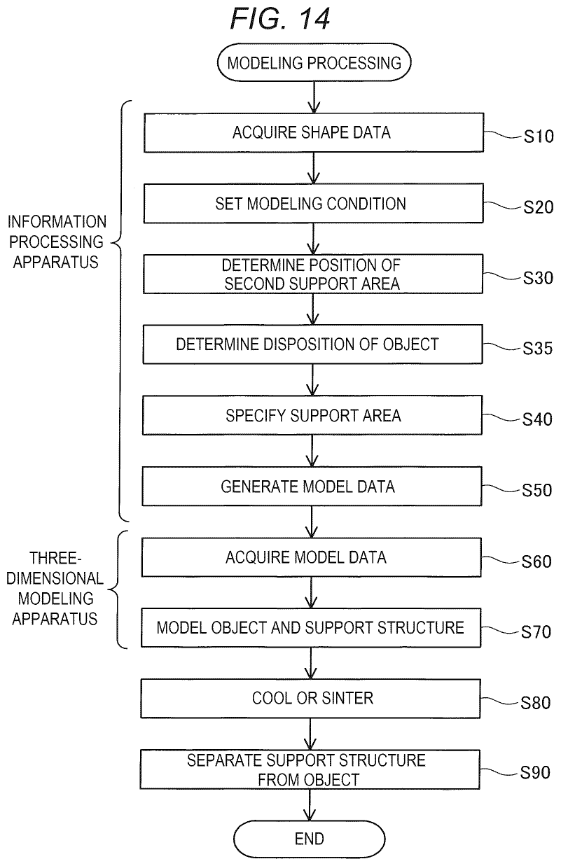

FIG. 14 is a flowchart of modeling processing in the third embodiment. In the third embodiment, processing of step S35 is added to the flowchart of the modeling processing shown in FIG. 7. In FIG. 14, step numbers having the same processing content as in FIG. 7 are given the same step numbers.

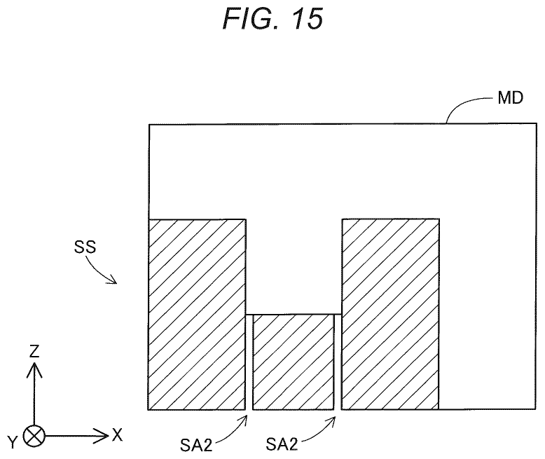

In the third embodiment, in step S35, the data generation unit 411 determines a position of the object MD based on the position of the second support area SA2 determined in step S30. For example, when the number of the set second support areas SA2 is larger than a predetermined number, the data generation unit 411 determines the position of the object MD with respect to the stage 210 such that the space formed in the second support area SA2 extends along the vertical direction. FIG. 15 shows a result of the process of step S35 in which the position of the object MD rotated by 90 degrees from a position shown in FIG. 6. As described above, by changing the position of the object MD according to the position of the second support area SA2, the material for modeling the first support structure and the third support structure is prevented from dripping due to gravity in the space formed in the second support area SA2, and the support structure SS can be modeled with high accuracy. As a result, the modeling accuracy of the object MD can be improved.

### D. Other Embodiments

(D1) In the above-described first embodiment, the second support area SA2 is an area in the body area BD among the base area BA, the contact area CA, and the body area BD constituting the support area SA. In contrast, at least a part of the second support area SA2 may be in the base area BA or the contact area CA. The data generation unit 411 may not specify the base area BA, the contact area CA, and the body area BD from the support area SA.
(D2) In the above-described embodiment, the three-dimensional modeling apparatus 100 includes the three modeling units 110. In contrast, the three-dimensional modeling apparatus 100 may include two or four or more modeling units 110. When the object MD and the support structure SS are modeled using the same type of material, the three-dimensional modeling apparatus 100 may include only one modeling unit 110.
(D3) In the above-described embodiment, the modeling unit 110 plasticizes the material by the flat screw 40. In contrast, the modeling unit 110 may plasticize the material by rotating an in-line screw, for example. The modeling unit 110 may plasticize a filament material with a heater.
(D4) In the above-described embodiment, a material extrusion method in which plasticized materials are deposited is described as an example, and the present disclosure can be applied to various methods such as an inkjet method, a direct metal deposition (DMD) method, and a binder jet method.

### E. Other Embodiments

The present disclosure is not limited to the embodiments described above, and can be implemented in various aspects without departing from the gist of the present disclosure. For example, technical features of the embodiments described above corresponding to technical features in the embodiments to be described below can be replaced or combined as appropriate in order to solve a part or all of problems, or in order to achieve a part or all of effects described above. The technical features can be deleted as appropriate unless described as being essential in the present description.
(1) According to a first aspect of the present disclosure, there is provided a method for manufacturing a three-dimensional object including: modeling an object by extruding a material onto a stage to deposit layers; and modeling a support structure in at least a part of a support area for supporting the object. The support area includes a first support area, a second support area adjacent to the first support area, and a third support area. The manufacturing method includes: a first step of modeling a first support structure in the first support area under a first modeling condition, and modeling a second support structure in the second support area under a second modeling condition, or forming a space without extruding the material; and a second step of separating the support structure from the object. The third support area is located between the second support area and the object, and the first modeling condition and the second modeling condition are modeling conditions different from each other. According to such an aspect, since the support structure can be easily separated from the object, a burden on a user can be reduced.
(2) In the above-described aspect, the modeling condition may be a condition related to at least one of a type of the material, a line width of the material, a depositing pitch of the material, and a modeling pattern of the material.
(3) In the above-described aspect, the method for manufacturing a three-dimensional object may further include: modeling a third support structure in the third support area, in which in the first step, the space may be formed in the second support area. According to such an aspect, the support structure can be easily separated from the object.
(4) In the above-described aspect, the method for manufacturing a three-dimensional object may further include: modeling a third support structure in the third support area, in which the object may contain a first metal, the first support structure and the third support structure may contain a second metal, and the second support structure may contain a ceramic; and before the second step, heating the object and the support structure at a temperature equal to or higher than a sintering temperature of the first metal and the second metal and lower than a sintering temperature of the ceramic. According to such an aspect, the support structure modeled by a metal can be easily separated.
(5) In the above-described aspect, the method for manufacturing a three-dimensional object may further include: before the first step, determining a position of the second support area based on an uneven structure of the object. According to such an aspect, the position of the second support area can be automatically determined.
(6) In the above-described aspect, the support area may include a base area in contact with the stage, a contact area in contact with the object at an upper side or a lower side, and a body area different from the base area and the contact area, and the second support area may be an area in the body area. According to such an aspect, it is possible to improve modeling accuracy of the object.
(7) In the above-described aspect, in the first step, the space may be formed in the second support area, and the method for manufacturing a three-dimensional object may further include: before the first step, determining a position of the object with respect to the stage such that the space extends along a vertical direction. According to such an aspect, it is possible to improve modeling accuracy of the object.

The present disclosure is not limited to the above-described method for manufacturing a three-dimensional object, and can be implemented by various aspects such as a three-dimensional modeling system, an information processing apparatus, a computer program, and a non-transitory tangible recording medium in which a computer program is recorded in a computer-readable manner.

What is claimed is:

1. A method for manufacturing a three-dimensional object comprising:
modeling an object by extruding a material onto a stage to deposit layers;
modeling a support structure in at least a part of a support area for supporting the object, the support area including a first support area, a second support area adjacent to the first support area, and a third support area;
a first step of modeling a first support structure in the first support area under a first modeling condition, and modeling a second support t structure in the second support area under a second modeling condition, or forming a space without extruding the material; and
a second step of separating the support structure from the object, wherein
the third support area is located between the second support area and the object, and
the first modeling condition and the second modeling condition are modeling conditions different from each other.

2. The method for manufacturing a three-dimensional object according to claim 1, wherein
the modeling condition is a condition related to at least one of a type of the material, a line width of the material, a depositing pitch of the material, and a modeling pattern of the material.

3. The method for manufacturing a three-dimensional object according to claim 1, further comprising:
modeling a third support structure in the third support area, wherein
in the first step, the space is formed in the second support area.

4. The method for manufacturing a three-dimensional object according to claim 1, further comprising:
modeling a third support structure in the third support area, in which
the object contains a first metal,
the first support structure and the third support structure contain a second metal, and
the second support structure contains a ceramic; and
before the second step, heating the object and the support structure at a temperature equal to or higher than a sintering temperature of the first metal and the second metal and lower than a sintering temperature of the ceramic.

5. The method for manufacturing a three-dimensional object according to claim 1, further comprising:
before the first step, determining a position of the second support area based on an uneven structure of the object.

6. The method for manufacturing a three-dimensional object according to claim 1, wherein
the support area includes a base area in contact with the stage, a contact area in contact with the object at an upper side or a lower side, and a body area different from the base area and the contact area, and
the second support area is an area in the body area.

7. The method for manufacturing a three-dimensional object according to claim 1, wherein
in the first step, the space is formed in the second support area, and
the method for manufacturing a three-dimensional object further comprises:
before the first step, determining a position of the object with respect to the stage such that the space extends along a vertical direction.
